(19) United States
(12) Patent Application Publication
(10) Pub. No.: US 2014/0289866 A1
(43) Pub. Date: Sep. 25, 2014

(54) METHOD AND SYSTEM FOR MOBILE OPERATING SYSTEM TAKEOVER

(71) Applicant: Famigo, Inc., Austin, TX (US)

(72) Inventors: Q Newton BECK, Austin, TX (US); Douglas FERGUSON, Austin, TX (US); John Russell ISTURIZ, Austin, TX (US); Matthew Martin MCDONNELL, Austin, TX (US)

(73) Assignee: Famigo, Inc., Austin, TX (US)

(21) Appl. No.: 14/186,890

(22) Filed: Feb. 21, 2014

Related U.S. Application Data
(60) Provisional application No. 61/767,538, filed on Feb. 21, 2013.

(51) Int. Cl. G06F 21/62

(52) U.S. Cl. CPC G06F 21/6209
USPC 726/28

(57) ABSTRACT

A software system stored in a memory in a mobile device for preventing access to software applications, said mobile device containing a plurality of software applications, the software system comprising means for allowing a first user to toggle the mobile device between a regular mode and a safe mode; means for identifying, based on information received over a communications network or based on selections by the first user, one or more of the software applications as restricted software applications and one or more of the software applications as safe software applications; means for preventing a second user different from the first user from accessing the restricted software applications while the mobile device operates in the safe mode by displaying a safe mode desktop that excludes icons for the restricted software applications; and means for allowing the first user to access the restricted software applications by displaying a regular desktop having icons for both the restricted software applications and the safe software applications while the mobile device operates in the regular mode.

### PRIORITY CLAIM

This application claims domestic priority based upon U.S. Provisional Patent Application Ser. No. 61/767,538, filed Feb. 21, 2013, the disclosure of which is hereby incorporated by reference.

### FIELD

The present disclosure relates to a system, components, and methodologies for restricting access to applications, content, and services on a mobile device. More specifically, the present disclosure is directed to systems, components, and methodologies that allow a parent to identify certain applications as restricted data applications and certain data services as restricted data services, such that a child using the mobile device in a Safe Mode cannot access the restricted data applications or restricted data services.

### BACKGROUND

Children using mobile devices continue to have increasing access to and appetite for mobile device usage. Meanwhile, parents are growing increasingly concerned about their children's safety with these devices. Specifically, parents are concerned as to whether their children are using applications, viewing content, or using data services that are suitable for their children.

Accordingly, there is a need for improved technological systems, components, and methodologies for restricting access to applications, content, and data services that a parent deems unsuitable for children.

### SUMMARY

According to the present disclosure, a software system is provided for restricting access to applications, content, and data services on a mobile device.

In illustrative embodiments, a software system stored in a memory in a mobile device containing a plurality of software applications comprises means for allowing a parent to toggle the mobile device between a Regular Mode and a Safe Mode; means for identifying, based on information received over a communications network or based on selections by the parent, one or more of the software applications as restricted software applications and one or more of the software applications as safe software applications; means for preventing a child from accessing the restricted software applications while the mobile device operates in the Safe Mode by displaying a Safe Mode desktop that excludes icons for the restricted software applications; and means for allowing the parent to access the restricted software applications by displaying a regular desktop having icons for both the restricted software applications and the safe software applications while the mobile device operates in the Regular Mode.

In illustrative embodiments, the software system also includes a Parent Mode, in which the parent can select software applications as being restricted software applications and select software applications as being safe software application, and can further identify certain data services as restricted data services. This allows for the restricted software applications and restricted data services to be inaccessible when the mobile device operates in a Safe Mode.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a block diagram showing the environment in which an exemplary system in accordance with the disclosure operates. It shows a mobile device that contains a software system, an operating system, third party software applications, a server having a database, and a communications network over which the mobile device can communicate with the database.

FIG. 2 shows a screen display in accordance with the disclosure by which a parent can enter a Parent Mode.

FIGS. 3A-3J show screen displays in accordance with the disclosure by which parents can select settings while in Parent Mode that will take effect when the device is later in Safe Mode. More specifically, FIG. 3A shows a screen display that appears when a parent enters Parent Mode, in which the parent is presented with various options for monitoring and modifying preferences related to third party applications stored on the mobile device.

FIG. 3B shows a screen display by which a parent selects an age range of a child in order to obtain recommendations for third party applications suitable for the child.

FIGS. 3C1 and 3C2 show alternative embodiments of a screen display by which a parent sets a swipe passcode that is required to exit Safe Mode.

FIG. 3D shows a screen display that may be displayed to a child that attempts to exit Safe Mode.

FIG. 3E shows a screen display for a tutorial directed to parents for how to manage the applications available in Safe Mode.

FIG. 3F shows another screen display for a tutorial that highlights the ability for a parent to unlock the device from Safe Mode (also sometimes referred to as Play Mode) and modify settings for the software system.

FIG. 3G shows another screen display for a tutorial directed to parents, this screen display explaining two modes of operation for the software system.

FIGS. 3H and 3I show alternative screen displays in accordance with the disclosure by which a parent may add applications from a mobile device to Safe Mode.

FIG. 3J shows a screen display in accordance with the disclosure by which a parent may remove applications from Safe Mode.

FIGS. 4A and 4B show screen displays or portions of screen displays in accordance with the disclosure by which parents can identify certain data services as restricted services.

FIG. 5 shows a screen display in accordance with the disclosure by which a parent can enter a swipe code to toggle the mobile device from a Safe Mode to a Regular Mode.

FIG. 6 shows a screen display in accordance with the disclosure that may appear after a parent adds a third party application to Safe Mode.

FIG. 7 shows a screen display in accordance with the disclosure that may appear after a parent enables certain Safe Mode data services for third party applications.

FIG. 8 is a flow diagram of an exemplary method in accordance with the disclosure by which applications are identified as safe software applications and restricted software applications, and by which a parent can identify data services as restricted data services.

FIG. 9 is a flow diagram of an exemplary method in accordance with the disclosure by which a child uses the mobile device in Safe Mode.

FIG. 10 is a flow diagram of an exemplary method in accordance with the disclosure by which a parent performs selections in Parent Mode, uses third party applications in Regular Mode, a child uses applications in Safe Mode, and then the parent returns to use third party applications in Regular Mode.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

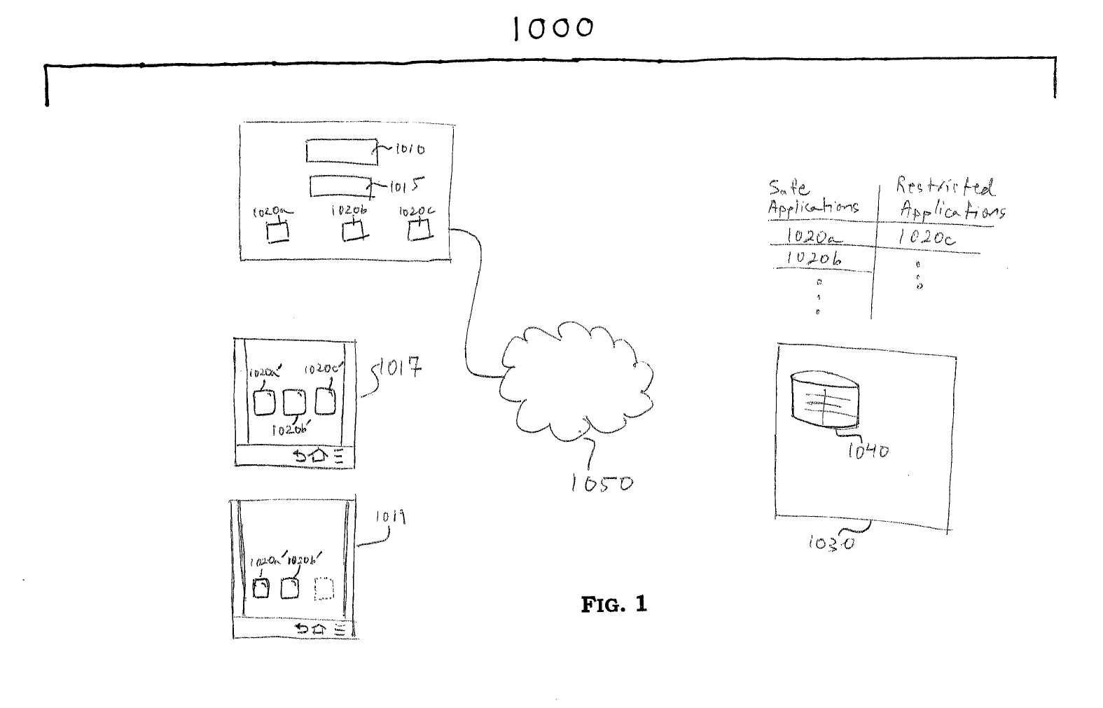

FIG. 1 shows a mobile device 1000, a software system 1010, a plurality of third party software applications 1020a, 1020b, and 1020c, a server 1030, a database 1040, and a network 1050. By way of overview, the software system 1010 can cause the mobile device 1000 to operate in either a Regular Mode, in which access to third party applications 1020a, 1020b, and 1020c and data services on the mobile device 1000 is not restricted, and a Safe Mode (also called Play Mode), in which access to certain third party applications 1020a, 1020b, or 1020c and certain data services on the mobile device 1000 is restricted.

A parent can operate the device in Regular Mode and toggle the device into Safe Mode before providing the device to a child. In Safe Mode, the software system 1010 takes control and/or overrides aspects of the mobile device 1010's operating system 1015 such that the mobile device 1010 shows a Safe Mode desktop. Whereas the Regular Mode desktop displays icons for and allows the parent to invoke any third party application 1020a, 1020b, or 1020c, the Safe Mode desktop only displays icons for and allows the child to invoke safe third party applications. The software system 1010 also disables and/or restricts data services that were identified as restricted while in Safe Mode.

The software system 1010 additionally provides a Parent Mode (also called a Manage Mode), in which the parent can determine which third party applications 1020a, 1020b, or 1020c should be considered restricted applications and which third party applications 1020a, 1020b, or 1020c should be considered safe. Alternatively, determinations on which applications should be considered restricted and which applications should be considered safe may come from the database 1040, or may be made based on other criteria to be discussed in more detail below. In Parent Mode, the software system 1010 also allows the parent to determine which data services should be restricted.

More particularly, according to this illustrative embodiment, mobile device 1000 is implemented as a mobile smartphone, but in other embodiments may be implemented as a tablet, a PDA, a multimedia computer, a laptop, and the like. Mobile device 1000 may include network connectivity, such as cellular network connectivity and/or wireless local area networking capabilities (i.e., “WiFi”).

The mobile device 1000 includes an operating system 1015 which may be selected from among Apple's iOS line of operating systems, the Android line of operating systems, the Windows Mobile or Windows Phone line of operating systems, or BlackBerry operating systems. Among other things, the operating system 1015 provides a graphical user interface that includes a Regular Mode desktop view 1017 containing icons 1020a′, 1020b′, and 1020c′ associated with respective third party applications 1020a, 1020b, and 1020c. A user of the mobile device 1000, such as a parent, can select one of the icons 1020a′, 1020b′, or 1020c′ to invoke a respective third party application 1020a, 1020b, or 1020c. For example, if the mobile device 1000 provides a touch screen, the user can touch on one of the icons 1020a′, 1020b′, or 1020c′.

Although the operating system 1015 provides the graphical desktop view 1017 in this illustrative embodiment, in other embodiments software applications may provide the graphical desktop view 1017. For example, the user of the mobile device 1000 may apply third party “skins” that provide an alternative graphical desktop view 1017 from what the operating system 1015 would natively provide.

Mobile device 1000 includes software system 1010, which allows the mobile device 1000 operate in Regular Mode, Parent Mode, and Safe Mode, to be discussed in more detail below. The software system 1010 may be implemented as a mobile application (“mobile app”), which is a software program or application designed to run on computers such as smartphones, tablet computers and other mobile devices. The software system 1010 may be made available through application distribution platforms operated by the owner of a mobile operating system, such as the Apple App Store, Google Play, Windows Phone Store or BlackBerry App World, from which a user downloads software system 1010 to the mobile device 1000. Alternatively, the software system 1010 may be provided at the point of distribution of the mobile device 1000, and may be part of the mobile device 100's native software. Software system 1010 may be implemented in Java, C, C++, C#, shell scripts, other known programming languages, or combinations thereof.

Mobile device also includes third party software applications 1020a, 1020b, and 1020c. Third party software applications 1020a, 1020b, and 1020c may be developed by application developers for use on mobile device 1000. As with software application 1010, the third party software applications 1020a, 1020b, and 1020c can be made available for user download through distribution platforms such as Apple App Store, Google Play, Windows Phone Store or BlackBerry App World. Though referred to herein as “third party” software applications, the third party software applications 1020a, 1020b, and 1020c can be provided on the mobile device 1000 at the time of distribution and/or as part the native software for mobile device 1000. Examples of third party software applications 1020a, 1020b, and 1020c include social media or social networking applications, gaming applications, multimedia content distribution applications, music or movie applications, podcast applications, office productivity applications, and the like.

The software system 1010 may identify certain third party software applications 1020a, 1020b, or 1020c as safe software applications and other third party software applications 1020a, 1020b, or 1020c as restricted software applications. For purposes of this illustrative embodiment, the third party software applications 1020a and 1020b are safe software applications and the third party software application 1020c is a restricted software application. The software application 1020c may be deemed as a restricted application because it is unsafe or inappropriate for children.

The software system 1010 may identify third party software applications 1020a, 1020b, or 1020c as safe applications or restricted applications in a variety of ways. In certain illustrative embodiments, a parent uses the software system 1010 to make selections as to which of the third party software applications 1020a, 1020b, or 1020c are to be considered safe applications and which are to be considered restricted applications.

In certain illustrative embodiments, the software system consults database 1040 to determine which of the third party software applications 1020a, 1020b, or 1020c are to be considered safe applications and which are to be considered restricted applications. The database 1040 is stored on a server 1030 and may be implemented using any known database environment, such as Oracle, DB2, or SQL Server. Database 1040 may be a relational database and server 1030 may be a database server.

The database 1040 may contain information regarding which of the third party software applications 1020a, 1020b, or 1020c are to be considered safe and which are to be considered restricted. This information may come from the provider of the software system 1010, which may also maintain and manage the database 1040. As shown in FIG. 1, in this illustrative embodiment, the database 1040 contents reflect that third party software applications 1020a and 1020b are safe applications, and third party software application 1020c is a restricted application.

In operation, the software system 1010 may conduct an inventory of the third party applications 1020a, 1020b, or 1020c that are stored on the mobile device. The software system 1010 may transmit the inventory to the database 1040 via the network 1050 and the server 1030. The database 1040 may be queried for each respective third party software application 1020a, 1020b, or 1020c included in the inventory as to determine whether each such third party software application should be deemed safe or restricted. The results of the queries are then transmitted back to software application 1010 via server 1030, network 1050, and mobile device 1000.

The software system 1010 communicates with the server 1030 through network 1050. Network 1050 may include any type of communication network, such as a cellular communication network, including but not limited to a second Generation (2G) network, a 2.5 Generation network, a third Generation (3G) network utilizing Global System for Mobile Communications (GSM), Wideband Code Division Multiplex Access (WCDMA), Code Division Multiplex Access (CDMA), or Time Division Multiplex Access (TDMA), General Packet Radio Services (GPRS), Universal Mobile Telephone System (UMTS). Network 150 can also be implemented as a combination of two or more technologies i.e., a hybrid network. Further, network 150 may also include generic Internet access using any transport methods.

It should further be understood that the mobile device 1000 may be coupled to a plurality of communication channels that allow the computer to communicate with other computing devices, e.g., servers, processors, etc. over, for example, one or more communication networks. As such, it should be understood that communication channels are examples of communications media, which typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The mobile device 1000 may be able to transmit and receive data over at least one cellular network and at least one wireless local area networking (e.g., “WiFi”) network.

It should also be understood that while database 1030 has been depicted as being located on a separate server 1040, it may also be located directly within mobile device 1000.

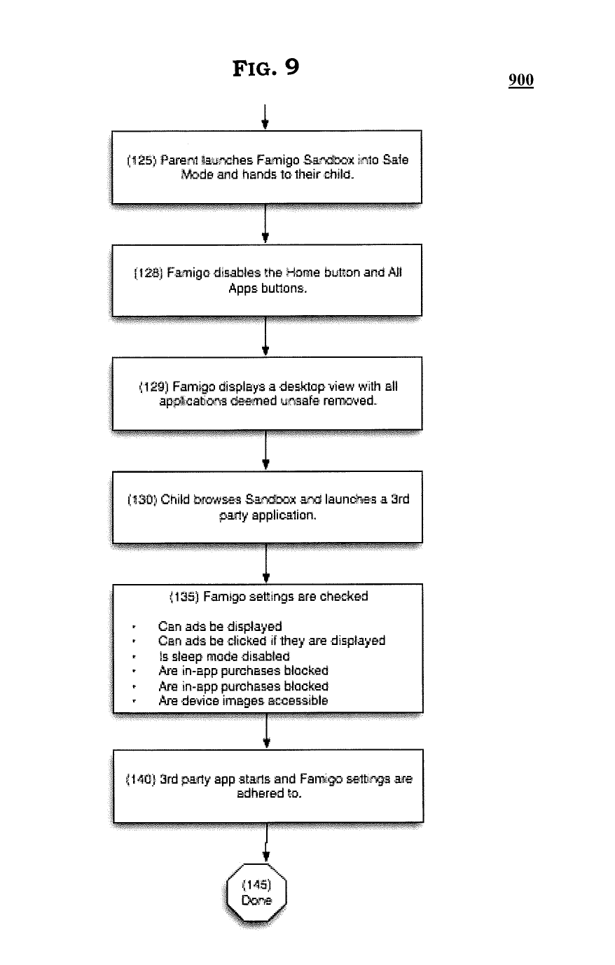

In some illustrative embodiments, the software system 1010 determines which of the third party software applications 1020a, 1020b, or 1020c should be considered safe by determining whether the third party software application is known to the safe. One method for determining whether the third party software application is known to be safe includes examining respective uniform resource locator (“URL”) information associated with the third party software applications 1020a, 1020b, or 1020c. Third party software applications 1020a, 1020b, or 1020c having a known URL scheme may be considered safe applications. Methods for using the database 1030 and URL recognition to identify safe third party applications will be discussed further in connection with the flow diagram 800 of FIG. 8, below.

As previously mentioned, the operating system 1015 provides a graphical user interface that includes a Regular Mode desktop view containing icons 1020a′, 1020b′, and 1020c′ associated with respective third party applications 1020a, 1020b, and 1020c. According to illustrative embodiments, when in Safe Mode, the software system 1010 takes over, overrides, or otherwise controls this aspect of the operating system 1015's functionality, and instead displays a Safe Mode desktop view 1019. In the Safe Mode desktop view 1019, icon 1020c′ corresponding to restricted third party software application 1020c is not displayed, as indicated by the dotted lines in FIG. 1. Instead, only the icons 1020a′ and 1020b′ are displayed in the Safe Mode desktop view 1019. In other illustrative embodiments, the icon 1020c′ is displayed in Safe Mode view 1019, but is deactivated. The icon 1020c′ may be dimmed, greyed out, or otherwise visually marked to indicate it is deactivated. In this manner, the restricted third party software application 1020c cannot be invoked in Safe Mode.

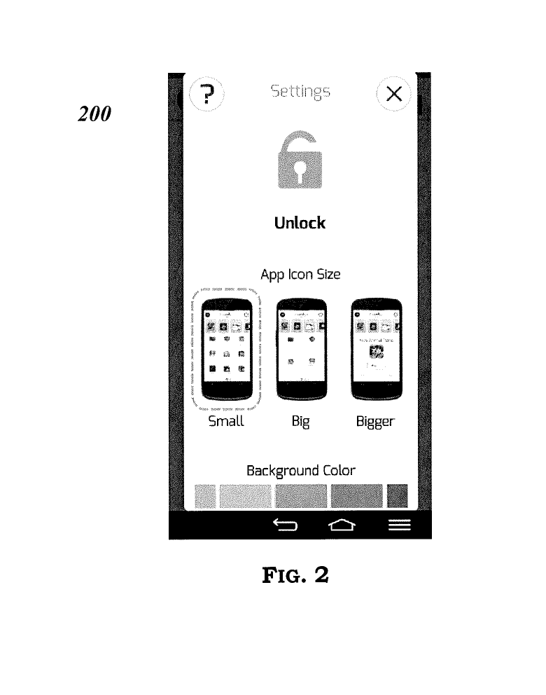

FIG. 2 shows a screen display 200 in accordance with the disclosure by which a parent can enter Parent Mode. As shown, the parent may need to unlock the device in order to enter the Parent Mode. Mechanisms for unlocking the device include having to enter a password, passcode, or other authentication mechanism.

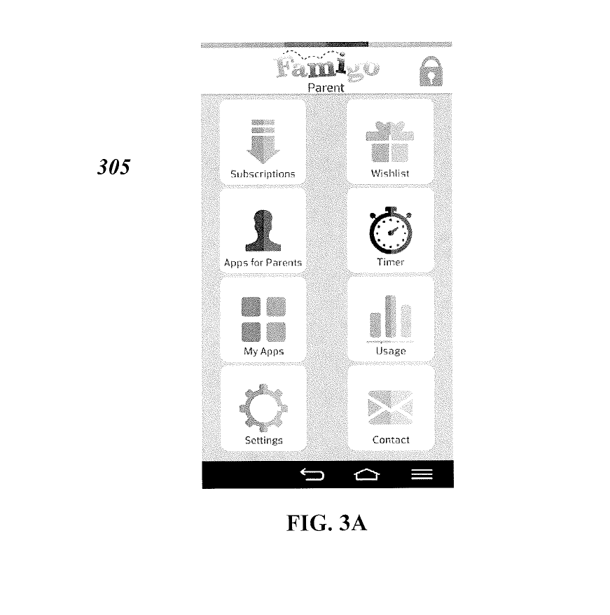

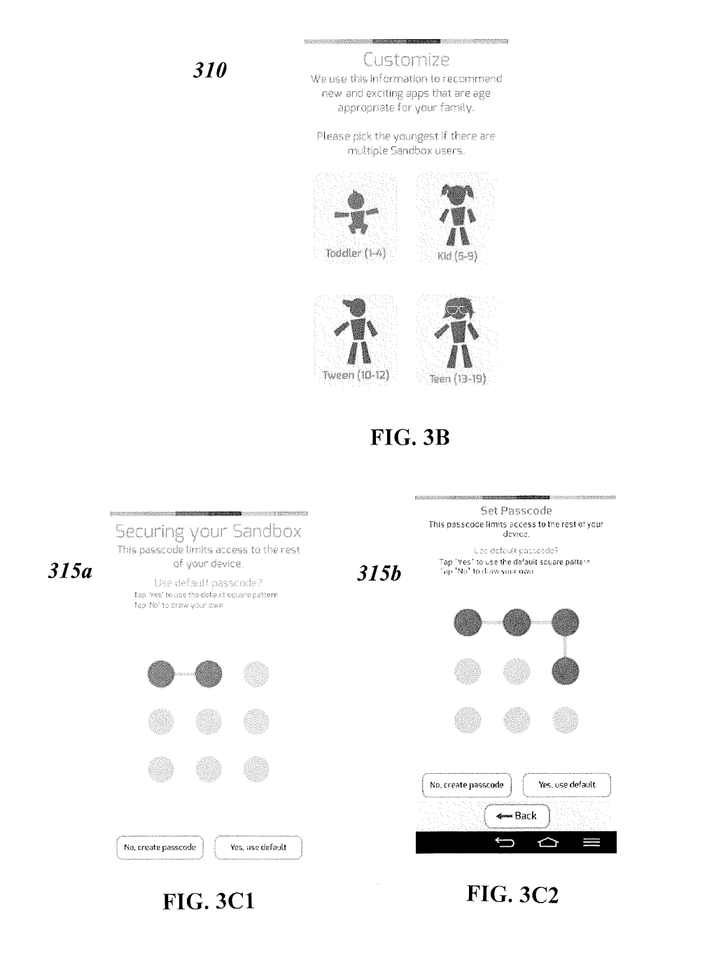

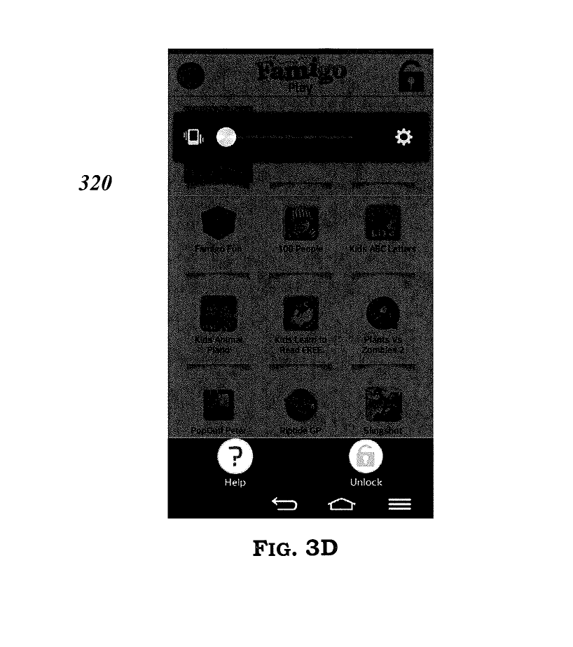

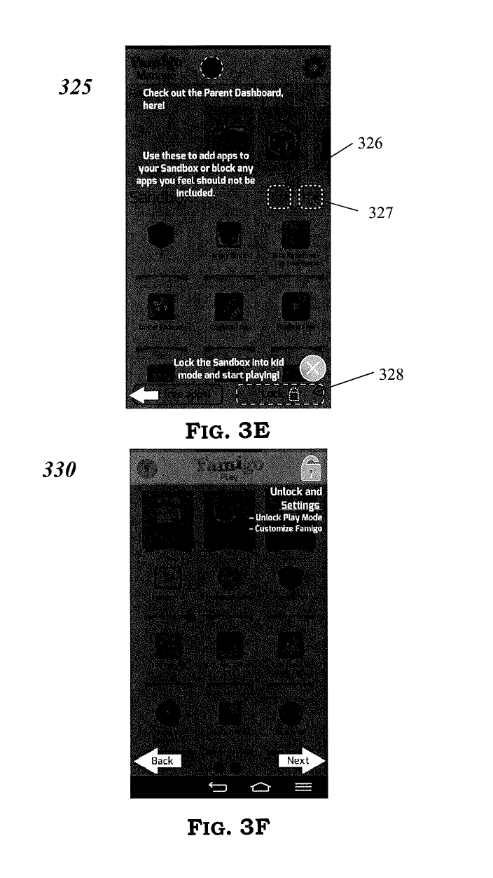

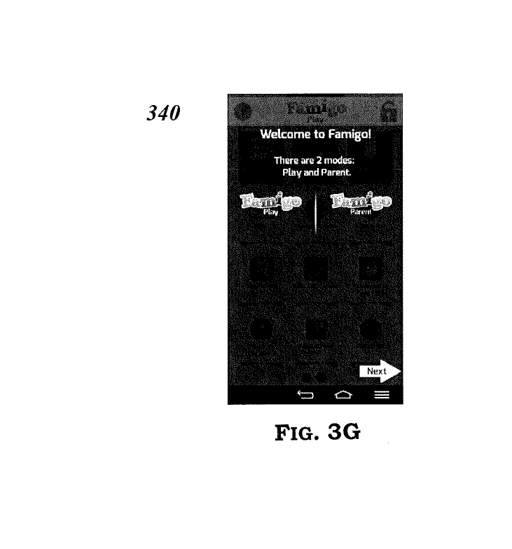

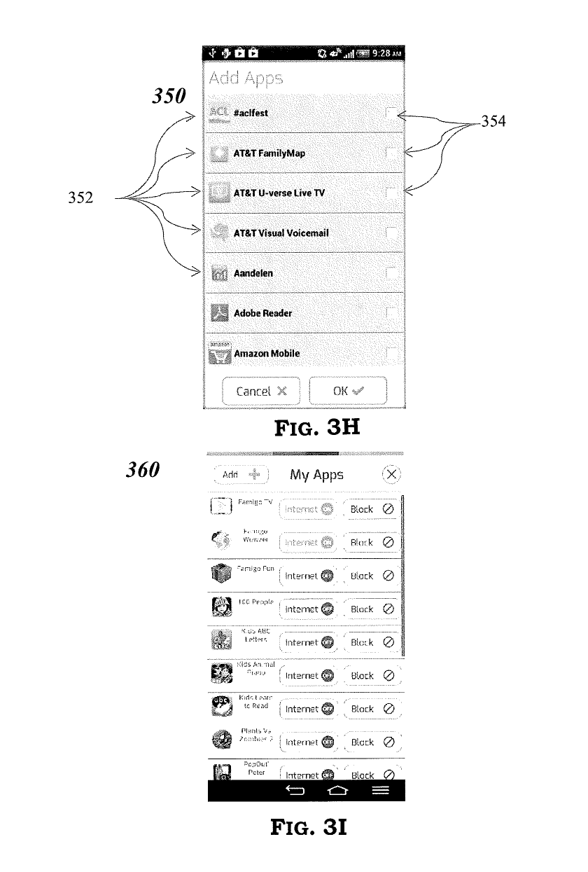

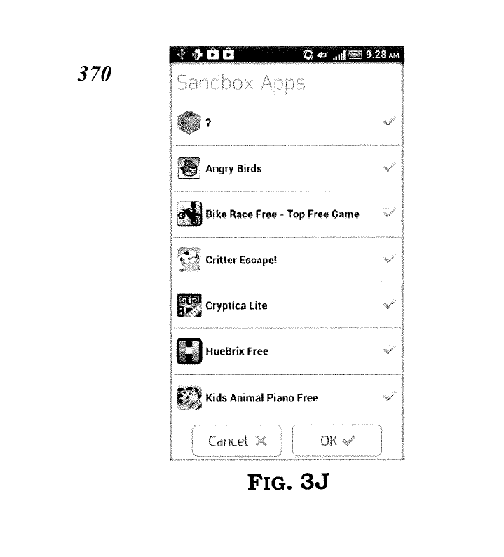

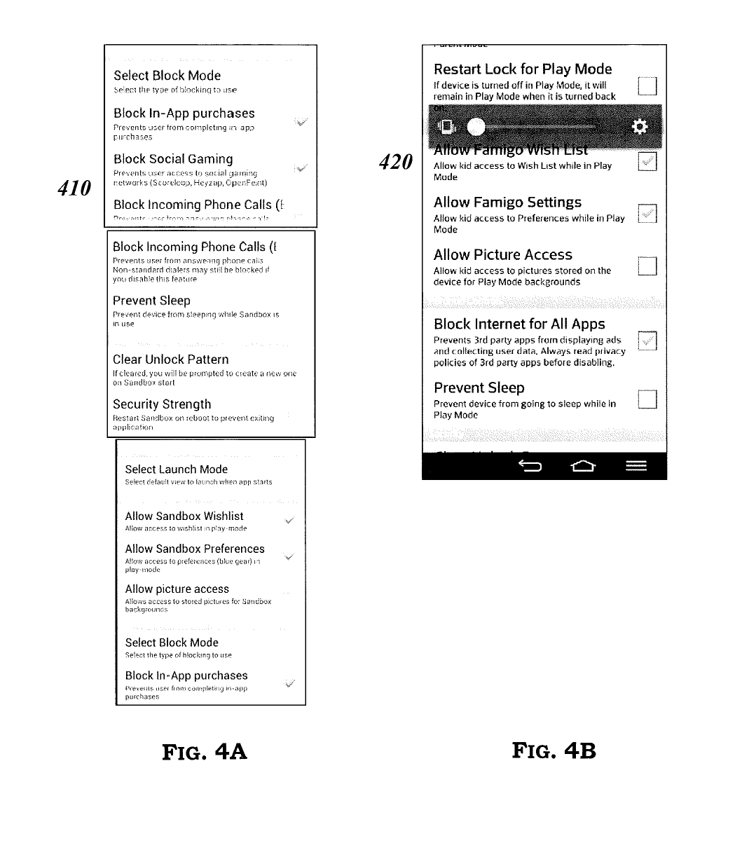

FIGS. 3A—3J show screen displays in accordance with the disclosure by which parents can select settings while in Parent Mode that will take effect when the device is later in Safe Mode. More specifically, FIG. 3A shows a screen display 305 that appears when a parent enters Parent Mode, in which the parent is presented with various options for monitoring and modifying aspects of the third party software applications stored on mobile device 1000. The options available to the parent include the ability to modify settings to take effect when the device is later put into Safe Mode, the ability to monitor usage (e.g., data usage) of the mobile device, and others.

FIG. 3B shows a screen display 310 by which a parent selects an age range of a child in order to obtain recommendations for third party applications suitable for the child. The recommendations may come from database 1040. For example, the database 1040 contents depicted in FIG. 1 may include additional database tables that contain information about third party applications suitable for various age groups. When the software system 1010 transmits a request for recommendations for a particular age group, that request may proceed through network 1050 to database 1040 via server 1030. The database may then be queried based on the requested age group. The database may then consult a database table or column of a table associated with that age group to identify one or more third party software applications suitable for the requested age group. The recommendations are then transmitted via server 1030 through network 1050 to the software system 1010 via mobile device 1000.

FIG. 3C shows alternative embodiments 315a and 315b of a screen display by which a parent sets a swipe code that will later be required to exit Safe Mode. Thus, when a child is using the mobile device in Safe Mode, the child will not be permitted to exit Safe Mode as to enter Regular Mode without entering the passcode. As depicted, the passcode is a “swipe” passcode, in which the user must follow a specific geometric sequence on the mobile device 1000's display screen.

FIG. 3D shows a screen display 320 that may be displayed to a child that attempts to exist Safe Mode. As shown, the screen dims and an “unlock” button appears. Because the child does not know the passcode that the parent set (as described in connection with FIG. 3C above), the child will be unable to unlock and exit Safe Mode.

FIGS. 3E and 3F show respective screen displays 325 and 330 for a tutorial directed to parents for how to manage applications available in Safe Mode. The screen display 325 shown in FIG. 3E highlights buttons 326 and 327 that the parent can use to identify third party software applications 1020a, 1020b, or 1020c as safe applications or restricted applications. The screen display 325 also highlights a button 328 that the parent can select to toggle mobile device 1000 into Safe Mode. FIG. 3F shows a screen display 330 that highlights the ability for a parent to unlock the device from Safe Mode (also sometimes referred to as Play Mode) into Parent Mode and modify settings for the software system 1010.

FIG. 3G shows another screen display 340 for a tutorial directed to parents, this screen display explaining two modes available for the software system 1010. As shown, the software system 1010 offers a Play Mode (also referred to as Safe Mode) and a Parent Mode. The Play Mode (or Safe Mode) is used when a child handles the mobile device 1000, and the Parent Mode is used when the parent wishes to, among other things, identify third party applications 1020a, 1020b, or 1020c as safe or restricted third party applications and/or to identify data services as restricted data services.

FIGS. 3H and 3I show alternative screen displays 350 and 360 in accordance with the disclosure by which a parent may add applications from a mobile device to Safe Mode. The screen display 350, by way of example, shows respective icons 352 associated with third party software applications. The icons are associated with checkboxes 354. The parent can select checkboxes for applications to add to Safe Mode, and then select the button marked “OK.”

FIG. 3I also shows a screen display 360 with respective icons associated with third party software applications. For each third party software application, the screen display 360 shows a button marked “Block” which can be used to indicate that the third party application is restricted. The screen display 360 also shows respective buttons marked “Internet,” which can be toggled to enable or disable data connectivity for that third party application.

FIG. 3J shows a screen display 370 in accordance with the disclosure by which a parent may remove applications from a Safe Mode. As with FIGS. 3H and 3I, the screen display 370 shows respective icons for various third party software applications. As with FIG. 3H, the screen display 370 includes checkboxes, this time having already been selected. A parent can unselect checkboxes to indicate that third party applications previously designated as suitable for Safe Mode should now be considered restricted.

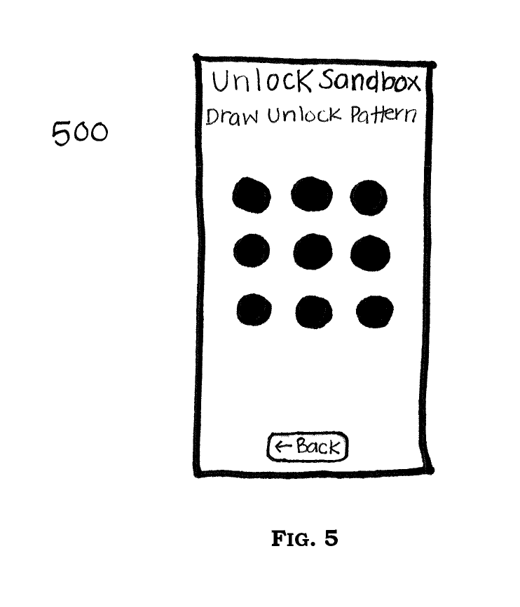

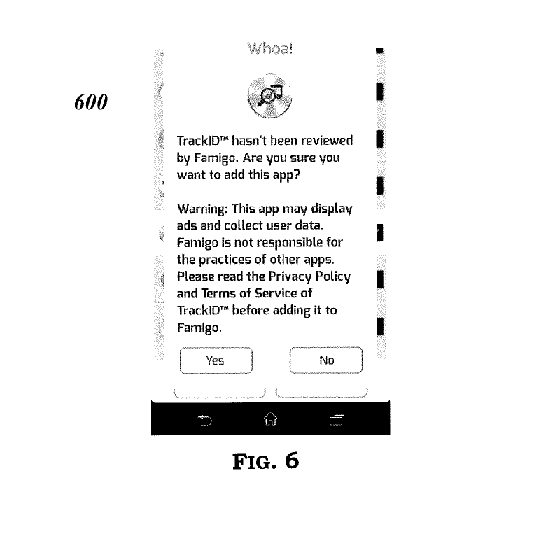

FIGS. 4A and 4B show screen displays or portions of screen displays in accordance with the disclosure by which parents can identify certain data services as restricted services. For example, the parent can disable or enable in-application purchases while in Safe Mode, disable or enable incoming calls while in Safe Mode, disable or enable device image access, and disable or enable sleep mode. Specifically, FIG. 4A shows screen display portions 410 with various options that can be selected or de-selected through checkboxes. As shown, the parent can select to block in-app purchases for third party software applications, block social gaming for third party software applications, block incoming phone calls, and prevent sleep mode. Also shown are options by which a parent can clear a passcode pattern used to unlock the mobile device 1000 from Safe Mode, and to enable the software system 1010 to directly proceed into Safe Mode upon restart of the mobile device 1000. Another option depicted in display portions 410 allows a parent to determine whether a child using the mobile device 1000 in Safe Mode can access pictures stored on a memory of the mobile device 1000.

FIG. 4B shows an alternative display screen 420 that includes similar options that can be selected or de-selected with checkboxes. The options depicted in the display screen 420 include an option to restart the mobile device 1000 in Safe Mode (shown as “Play Mode” in the Figure), an option to allow a child to access certain settings while in Safe Mode (shown as “Play Mode” in the Figure), an option to allow a child to access pictures stored on the mobile device 1000 while in Safe Mode, an option to block Internet access for third party applications, and an option to prevent the mobile device 1000 from going into sleep mode.

Other embodiments allow a parent to adjust still other settings. For example, the software system 1010 may allow the parent to enable or disable the operating system 1015's call dialer or messenger (e.g., SMS or MMS) applications. The software system 1010 may also allow the parent to enable or disable social media or social gaming.

In order to enable or disable the various data services identified above, the software system 1010 may take control or otherwise override aspects of the operating system 1015 responsible for controlling those aspects of the mobile device 1000's data services.

As explained, a parent can use software system 1010 to toggle the mobile device 1000 from Safe Mode to Regular Mode using a passcode. FIG. 5 shows a screen display 500 onto which the parent can enter a geometric passcode (as described above in connection with FIG. 3C) in order to toggle the mobile device 1000 out of Safe Mode.

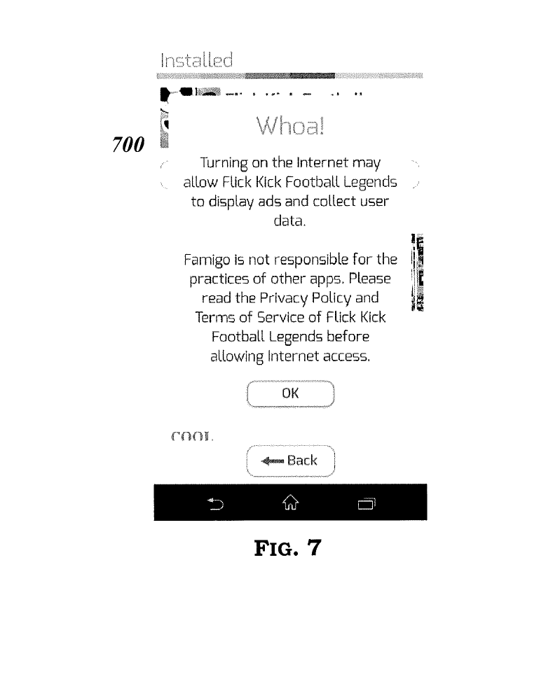

FIG. 6 shows a screen display 600 that the software system 1010 may display after a parent selects a third party application 1020a, 1020b, or 1020c as being a safe software application. As shown, the software system 1010 may display a warning notice indicating that by identifying the third party application 1020a, 1020b, or 1020c as safe, the third party application 1020a, 1020b, or 1020c may display advertising to a child or collect personally identifiable information (“PII”) from a child using the mobile device 1010.

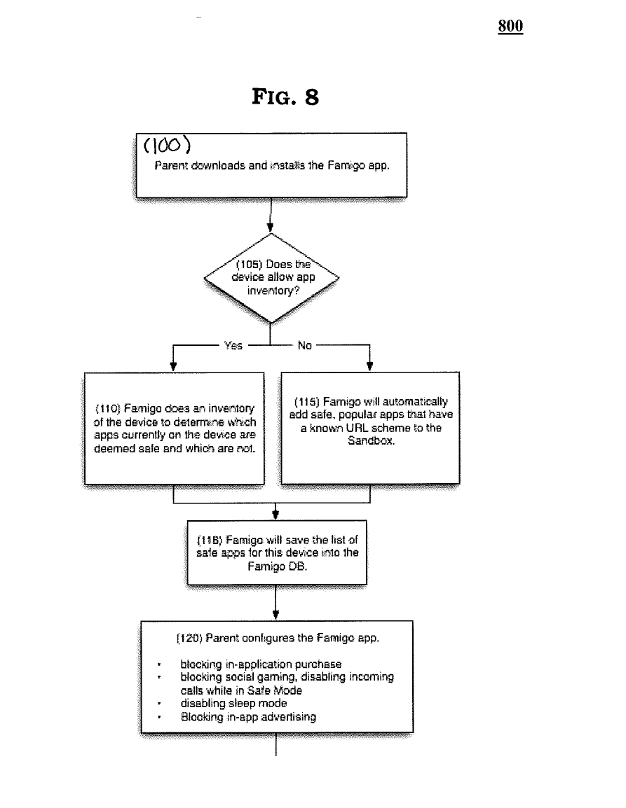

FIG. 7 shows a screen display in accordance with the disclosure that may appear after a parent removes restrictions from certain data services for third party applications 1020a, 1020b, or 1020c. In the illustrative embodiment of FIG. 7, the parent has elected to allow Internet access for a third party application 1020a, 1020b, or 1020c while in Safe Mode. By way of example, the parent may have elected to allow Internet Access using the functionality described above in connection with FIG. 3I. As shown on the screen display 700, the software system 1010 may display a warning notice indicating that by enabling Internet access, the third party application 1020a, 1020b, or 1020c may display adds to a child or collect PII from a child using the mobile device 1000.

FIG. 8 is a flow diagram 800 of an exemplary method in accordance with the disclosure by which applications are identified as safe software applications and restricted software applications, and by which a parent can identify data services as restricted data services. The method begins with step 100, by which a parent downloads and installs the software system 1010 (identified in FIG. 8 as the “Famigo app”). The method proceeds to step 105, whereby the software system 1010 determines whether the mobile device 1000 and/or its operating system 1015 allow the software system 1010 to conduct an inventory of third party applications 1020a, 1020b, or 1020c stored on the mobile device 1000. If so, the method proceeds to step 110, in which the software system 1010 (identified as “Famigo” in the Figure) performs an inventory of the third party applications 1020a, 1020b, or 1020c to determine which are safe and which are restricted. As previously explained, the software system 1010 may obtain information on which third party applications 1020a, 1020b, or 1020c are safe and which are restricted through communication with database 1040. As also explained, the database 1040 may be located on a remote server 1030 or within the mobile device 1000.

If the mobile device 1000 does not allow for an inventory, the software system 1010 will proceed to step 115. In this step, and as explained above, the software system 1010 identifies respective URL schemes associated with the third party applications 1020a, 1020b, or 1020c. The software system 1010 identifies those third party applications 1020a, 1020b, or 1020c having known URL schemes as safe applications, and identifies all other third party applications 1020a, 1020b, or 1020c as restricted applications.

The software system 1010 then proceeds to step 118, where it saves the list of safe third party applications 1020a, 1020b, or 1020c into the database 1040.

Finally, the software system 1010 proceeds to step 120, in which it allows a parent to restrict certain data services. The parent can restrict data services using the functionality previously described in connection with FIGS. 4A and B.

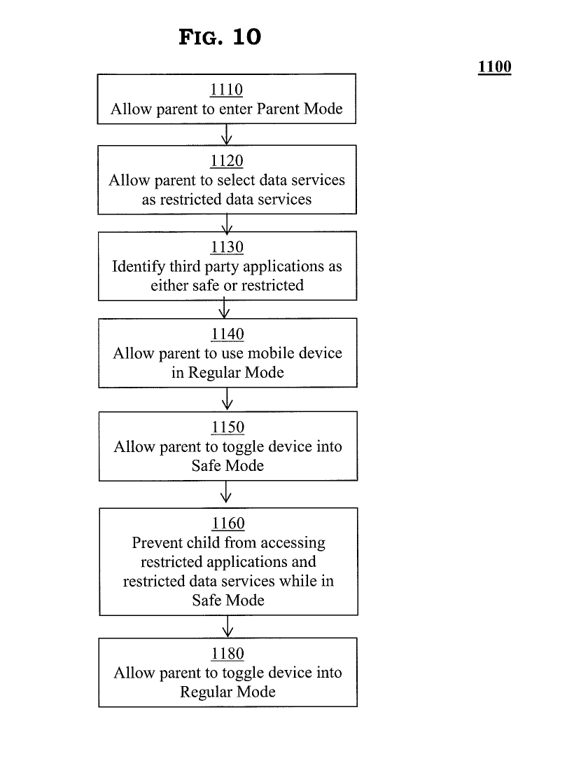

FIG. 9 is a flow diagram of an exemplary method 900 in accordance with the disclosure by which a child uses the mobile device in Safe Mode. The method starts in step 125, in which a parent uses software system 1010 to toggle the mobile device 1000 from Regular Mode into Safe Mode and provides the mobile device 1000 to a child. In step 128, The software system 1010 disables certain buttons, including a Home button (which would ordinarily allow the user to proceed to a Home screen of the operating system 1015) and the All Apps button (which ordinarily would display to a user all third party applications stored on mobile device 1000).

In step 129, the software system 1010 displays a Safe Mode desktop, such as that depicted as element 1019 in FIG. 1. The third party application 1020c that was deemed unsafe has been removed from view, in that its icon 1020c′ does not appear.

In step 130, the software system 1010 allows the child to browse the operating environment made available by software system 1010, referred to in the Figure as a “Sandbox.” The Sandbox shows the Safe Mode desktop, in which the child can browse third party applications 1020a and 1020b that have been deemed safe, and launch one of those third party applications.

The software system 1010 then proceeds to step 135, in which it checks user preference settings that were previously selected by a parent. The functionality by which a parent can select the settings depicted in FIG. 9 was described above in connection with FIGS. 4A and 4B. In FIG. 9's illustrative embodiment, the software system 1010 checks the parent's user preference settings as to whether advertisements can be displayed, whether advertisements can be clicked to the extent they are displayed, whether the mobile device 1000's sleep mode is enabled, whether in-app purchases are blocked, and whether images stored on mobile device 1000 should be accessible to the child.

The software system 1010 then proceeds to step 140, in which the third party application 1020a or 1020 that was selected by the child is launched, with the previously described user preferences enforced.

FIG. 10 is a flow diagram of an exemplary method in accordance with the disclosure by which a parent performs selections in Parent Mode, uses third party applications in Regular Mode, a child uses safe third party applications in safe mode, and then the parent returns to use third party applications in Regular Mode.

In step 1110, the software system 1010 allows a parent to begin in Regular Mode and enter Parent Mode. In step 1120, while in Parent Mode, the software system 1010 allows the parent to select data services that should be restricted. In step 1130, the software system 1010 identifies third party applications as either safe or restricted. As explained, the identification can be based on user preference selections by the parent, based on querying the database 1030, based on recognition of URLs associated with third party applications, or other methods.

In step 1140, the software system 1010 allows the parent to use the mobile device in Regular Mode, in which the parent has access to all of the third party applications 1020a, 1020b, and 1020c.

In step 1150, the software system 1010 allows the parent to toggle the device into Safe Mode. The parent can then provide the mobile device to a child. In step 1160, while in Safe Mode, the software system 1010 allows the child to access safe applications 1020a and 1020b, but prevents the child from accessing restricted applications 1020c and from accessing restricted data services. Finally, in step 1180, the parent can retrieve the mobile device and toggle the device, such as by entering a passcode, into Regular Mode.

The mobile device 1000 and/or the server 1030 may include computer-readable media for carrying or having computer-executable instructions or data structures stored thereon.

Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions.

Accordingly, although not illustrated, it should be understood that the mobile device 1000 and/or the server 1030 may include a processor connected to a user interface, computer readable memory and/or other data storage and a display and/or other output device. The mobile device 1000 and/or the server 1030 may also include a power supply, and a user interface, such as a keypad, touch screen, voice interface, one or more arrow keys, joy-stick, data glove, mouse, roller ball, touch screen or the like.

Computer executable instructions and data used by a processor included in mobile device 1000 and/or server 1030 may be stored in the computer readable memory included the respective mobile device 1000 and/or server 1030. Further, the memory if the mobile device 1000 and/or server 1030 may be implemented with any combination of read only memory modules or random access memory modules, optionally including both volatile and nonvolatile memory. Further, software may be stored within the memory and/or storage to provide instructions to the mobile device 1000 and server 1030 for enabling them to perform various functions. Alternatively, some or all of the mobile device computer executable instructions may be embodied in hardware or firmware (not illustrated).

The mobile device 1000 includes antennaes for data transmission and reception. Mobile device 1000 may have capability to communicate with one or more different types of communication networks and have messaging capabilities including, e.g., a Short Message Service (SMS) client, electronic mail client, or Multimedia Message Service client embedded in mobile device 1000. Mobile device 1000 may also include a browser configured to access Web and/or Wireless Application Protocol (WAP) services.

It should be understood that memory of mobile device may include many databases that separately include, for example, subscriber profile information, advertising content, archive data, etc. or some combination or all of this information and data may be included in a single database.

It should also be understood that while database 1030 has been depicted as being located on a separate server 1040, it may also be located directly within mobile device 1000.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Although certain illustrative embodiments have been described in detail above, variations and modifications exist within the scope and spirit of this disclosure as described and as defined in the claims included in this application.

What is claimed is:

1. A software system stored in a memory in a mobile device for preventing access to software applications, said mobile device containing a plurality of software applications, the software system comprising:
means for allowing a first user to toggle the mobile device between a regular mode and a safe mode;
means for identifying, based on information received over a communications network or based on selections by the first user, one or more of the software applications as restricted software applications and one or more of the software applications as safe software applications;
means for preventing a second user different from the first user from accessing the restricted software applications while the mobile device operates in the safe mode by displaying a safe mode desktop that excludes icons for the restricted software applications; and
means for allowing the first user to access the restricted software applications by displaying a regular desktop having icons for both the restricted software applications and the safe software applications while the mobile device operates in the regular mode.

2. The software system of claim 1, further comprising means for allowing the first user to select one or more of the software applications as restricted software applications and to select one or more of the software applications as safe software applications.

3. The software system of claim 2, further comprising
means for allowing the first user to identify one or more data services as restricted data services; and
means for preventing the second user from accessing the restricted data services while the mobile device operates in the safe mode.

4. The software system of claim 3, wherein the restricted data services are selected from among calls, advertising, social gaming, and purchases.

5. The system of claim 1, wherein the means for identifying one or more of the software applications as restricted software applications and one or more of the software applications as safe software applications comprises
means for creating an inventory of the plurality of software applications stored on the mobile device;
means for communicating the inventory to a database operatively coupled to the mobile device over a communications network; and
means for receiving from the database identifications of the restricted software applications and identifications of the safe software applications.

6. The system of claim 1, wherein the means for identifying one or more of the software applications as restricted software applications and one or more of the software applications as safe software applications comprises
means for identifying a uniform resource locator associated with a given software application;
means for determining whether the uniform resource locator is a trusted uniform resource locator; and
identifying the given software applications as one of the safe software applications upon a determination that the uniform resource locater is a trusted uniform resource locator.

7. A method for preventing access to software applications stored in a memory in a mobile device containing a plurality of software applications, comprising:
identifying one or more of the software applications as restricted software applications and one or more of the software applications as safe software applications;
allowing the mobile device to toggle between a regular mode and a safe mode;
preventing access to the restricted software applications while the mobile device operates in the safe mode; and
allowing access to the restricted software applications while the mobile device operates in the regular mode.

8. The method of claim 7, further comprising
allowing a first user of the mobile device to toggle between the regular mode and the safe mode;
preventing a second user different from the first user from accessing the restricted software applications while the mobile device operates in the safe mode; and
allowing the first user to access the restricted software applications while the mobile device operates in the regular mode.

9. The method of claim 7, further comprising
displaying a safe mode desktop that excludes icons for the restricted applications while the mobile device operates in the safe mode; and
displaying a regular desktop having icons for both the restricted applications and the safe software applications while the mobile device operates in the regular mode.

10. The method of claim 7, further comprising
allowing a first user to select one or more of the software applications as restricted software applications and to select one or more of the software applications as safe software applications.

11. The method of claim 7, further comprising
allowing a first user to identify one or more data services as restricted data services; and
preventing a second user different from the first user from accessing the restricted data services while the mobile device operates in the safe mode.

12. The method of claim 11, wherein the restricted data services are selected from among calls, advertising, social gaming, and purchases.

13. The method of claim 7, further comprising
creating an inventory of the plurality of software applications stored on the mobile device;
communicating the inventory to a database operatively coupled to the mobile device over the communications network; and
receiving from the database identifications of the restricted software applications and identifications of the safe software applications.

14. The method of claim 7, further comprising
identifying a uniform resource locator associated with a given software application;
determining whether the uniform resource locator is a trusted uniform resource locator; and
identifying the given software applications as one of the safe software applications upon a determination that the uniform resource locater is a trusted uniform resource locator.

15. The method of claim 7, further comprising
allowing a user to manually identify one or more of the software applications as restricted software applications and one or more of the software applications as the safe software applications.

16. A software system for preventing access to software applications stored in a memory in a mobile device containing a plurality of software applications, comprising:
computer readable code stored on a non-transitory data storage component in operative communication with a processor for the mobile device, wherein said computer readable code, when executed on the processor, causes the mobile device to:
identify one or more of the software applications as restricted software applications and one or more of the software applications as safe software applications;
allow the mobile device to toggle between a regular mode and a safe mode;
prevent access to the restricted software applications while the mobile device operates in the safe mode; and
allow access to the restricted software applications while the mobile device operates in the regular mode.

17. The software system of claim 16, wherein said computer readable code, when executed on the processor, further causes the mobile device to
allow a first user of the mobile device to toggle between the regular mode and the safe mode;
prevent a second user different from the first user from accessing the restricted software applications while the mobile device operates in the safe mode; and
allow the first user to access the restricted software applications while the mobile device operates in the regular mode.

18. The software system of claim 16, wherein said computer readable code, when executed on the processor, further causes the mobile device to
display a safe mode desktop that excludes icons for the restricted applications while the mobile device operates in the safe mode; and
display a regular desktop having icons for both the restricted applications and the safe software applications while the mobile device operates in the regular mode.

19. The software system of claim 16, wherein said computer readable code, when executed on the processor, further causes the mobile device to
allow a first user to select one or more of the software applications as restricted software applications and to select one or more of the software applications as safe software applications.

20. The software system of 16, wherein said computer readable code, when executed on the processor, further causes the mobile device to
allow a first user to identify one or more data services as restricted data services; and
prevent a second user different from the first user from accessing the restricted data services while the mobile device operates in the safe mode.

21. The software system of 20, wherein the restricted data services are selected from among calls, advertising, social gaming, and purchases.

22. The software system of 16, wherein said computer readable code, when executed on the processor, further causes the mobile device to
create an inventory of the plurality of software applications stored on the mobile device;
communicate the inventory to a database operatively coupled to the mobile device over the communications network; and
receive from the database identifications of the restricted software applications and identifications of the safe software applications.

23. The software system of 16, wherein said computer readable code, when executed on the processor, further causes the mobile device to
identify a uniform resource locator associated with a given software application;
determine whether the uniform resource locator is a trusted uniform resource locator; and
identify the given software applications as one of the safe software applications upon a determination that the uniform resource locater is a trusted uniform resource locator.

24. The software system of 16, wherein said computer readable code, when executed on the processor, further causes the mobile device to
allow a user to manually identify one or more of the software applications as restricted software applications and one or more of the software applications as the safe software applications.
